(19) United States
(12) Patent Application Publication
(10) Pub. No.: US 2013/0125758 A1
(43) Pub. Date: May 23, 2013

(54) DEVICE FOR PREPARING AND DISPENSING OF A DRINK AND PRODUCT HOLDER FOR USE THEREIN

(71) Applicants: Erik Arnold Lodeweges, GR Enschede (NL); Jacques Andreas Bernardus Wanders, VV Ulft (NL)

(72) Inventors: Erik Arnold Lodeweges, GR Enschede (NL); Jacques Andreas Bernardus Wanders, VV Ulft (NL)

(73) Assignee: ETNA COFFEE TECHNOLOGIES B.V., PB Lichtenvoorde (NL)

(21) Appl. No.: 13/695,958

(22) PCT Filed: May 3, 2011
(86) PCT No.: PCT/NL2011/050302

§ 371 Date: Jan. 15, 2013

(30) Foreign Application Priority Data
May 3, 2010 (NL) 2004652

(51) Int. Cl. A47J 31/40

(52) U.S. Cl. CPC A47J 31/404
USPC 99/275

(57) ABSTRACT

A device for preparing and dispensing a drink comprises a dosing device (21,22) for a product to be mixed with a liquid in a mixing chamber (50), wherein the drink prepared therefrom can be drawn off at an outlet (60). The dosing device (21,22) is provided with a placing space for an exchangeable product holder (31,32), an outflow opening of which is at least initially provided with a removable seal (33 . . . 35). The seal comprises a foil folded back on itself, a base part (33) of which is attached to an edge (37,38) of the product holder (31,32) and a folded further part (34) of which leads back to a front side and protrudes with a pulling part (35) out of the placing space. At least the folded part (34) of the foil is laterally movable inside the placing space in order to allow removal of the foil from a placed product holder.

The present invention relates to a device for preparing and dispensing a drink, comprising a mixing chamber with supply means for a liquid, in particular hot water, with at least one dosing device for a controlled delivery of a product to be mixed with the liquid in the mixing chamber, and with an outlet at which a prepared drink can be drawn off, wherein the dosing device comprises a product chamber from where the product is dispensed in controlled manner on an outlet side and wherein the dosing device is provided on an inlet side with a placing space for an exchangeable product holder in open communication at an outflow opening with the product chamber, the outflow opening at least initially being provided with a removable seal.

Such a device is applied on a large scale as coffee machine in offices and in workplaces, and is characterized by convenience of use. The device is normally connected to a fixed water main from which cold water is obtained. The device has heating means such as a boiler or a heat block with which water is heated to a desired preparation temperature and delivered in a predetermined quantity to the mixing chamber. Also present in the device are one or more dosing devices with a product holder in which a product for mixing is held. On the basis of a product selection entered by the user one or more dosing devices corresponding to the product selection are addressed and from the product chamber thereof a quantity of product is dosed as prescribed by a product recipe. These are mainly products in powder form, such as powdered milk, sugar, cocoa powder and coffee powder, although the invention is also suitable for dosing of such products in wet liquid form. No or hardly any intervention of a user is thus required for the preparation of a beverage desired by the user and the preparation process takes place fully automatically.

As soon as a product holder is empty it can be replaced by a new, full product holder. This is described for instance in international patent application WO 2005/120314 on the basis of a device of the type described in the preamble. The dosing device is for this purpose wholly removed from the device together with the empty product holder and the product holder is removed therefrom. An outlet of the dosing device is closed beforehand with a cover provided thereon for the purpose of avoiding spillage of product residues. A new product holder, the outflow opening of which is still sealed, is then placed in the placing space of the dosing device intended for this purpose, and only then is the seal removed by being pulled loose from a rear side. The product then drops out of the product holder into the product chamber of the dosing device. This latter can now be re-placed in the device and is once again available for a following series of dosages of the product to be obtained therefrom as soon as the outlet thereof is once again opened.

Although this known device provides per se an elegant and particularly user-friendly solution for providing a tasty, freshly prepared beverage in varied locations and situations, the replacement of a product holder is nevertheless perceived as time-consuming In a first aspect the present invention therefore has for its object to simplify the replacement of a product holder.

In a second aspect the present invention has for its object to provide a device for preparing and dispensing a drink with a number of dosing devices of more stable and therefore more operationally reliable construction.

In a third aspect the present invention has for its object to provide a device for preparing and dispensing a drink with an electronic control system which, in conjunction with the product holder, is capable of an improved control of the nature and quality of the drink to be prepared.

In order to achieve said third object a device of the type described in the preamble has the feature according to the invention that the product holder is provided with an electronically readable information carrier, that at least close to the placing space electronic reading means are provided which are able and adapted to read information from the information carrier of a product holder placed therein, and that the reading means are coupled to an electronic control system which controls the device on the basis of at least the information thus readable from the product holder. The invention thus integrates the product holder into the overall control system of the device. This opens the way to numerous new and ground-breaking possibilities in the field of coffee machines and similar devices.

In a first particular embodiment the device according to the invention, by way of example hereof, is characterized in that the information carrier comprises an at least substantially unique product holder identification and that the product holder identification is readable by the reading means. The product holder is thus identified in at least substantially unique manner for the control system. This may involve an individual identification of the product holder or a collective identification, for instance in the form of a batch number of a production run in which the product holder has been filled or produced in a group of product holders. In both cases the invention provides an improved traceability, both upward and downward in a distribution chain, of a product holder once it has been made available for use.

When the device is equipped with a telecommunication or network interface for information exchange via an optionally adapted data network with a central management system, it is moreover thus possible when a quality problem is found to exchange the relevant product holder identifications with the device so that the device no longer accepting generates a warning or message to the user and optionally reports itself to the management system in order to thereby pass on the location of the product holder so that an appropriate action can be taken. The invention thus provides an unparalleled monitoring of the quality and integrity of a product generated in the distribution chain, this being of great advantage not only from the viewpoint of product liability but particularly also in avoiding reputation damage.

The system can moreover thus keep track of a number of dosages that have been drawn from the product holder and subsequently give timely warning of a level below a predetermined minimum. Furthermore, refilling of a product holder with an alien product can thus be prevented in effective manner because a product holder assumed by the system to be empty or at least substantially empty is no longer accepted by the system. The quality and integrity of the product can hereby be monitored efficiently.

A further particular embodiment of the device according to the invention has, by way of such an example, the feature that the information carrier comprises a product identification of a product arranged in the product holder and that the product identification is readable by the reading means. Because the nature and possible concentration of the product is thus known in the control system, the control system can take advantage of this, for instance by giving a user an error message if an incorrect product has been installed or by routing the delivery of an ingredient, unnoticed by the user, to a correct product holder anywhere in the device.

Although the control system of the device will normally have access to a library of standard preparation programs for the beverages to be prepared, the device according to the invention provides further possibilities for adapting the device to the specific wishes of an end user, distributor or reseller. A further particular embodiment of the device according to the invention has for this purpose the feature that the information carrier comprises at least one recipe for a drink to be prepared from at least a product received in the product holder, and that the at least one recipe is readable by reading means. One or more specific recipes can thus be stored in the information carrier, on the basis of which the device will mix a beverage to be prepared therefrom. Such a recipe can here be customer-specific and be geared to the taste or the desired consumption of a customer/end user. Because all recipe data are stored on the product holder itself, this results in an exceptionally flexible and widely usable platform for the distribution of devices and product holders according to the invention.

A further option is provided by a further particular embodiment of the device which is characterized according to the invention in that the information carrier comprises a customer identification and that the customer identification is readable by the reading means. The control system of the device can have customer information available here and control the device on the basis thereof. This control can involve a personalization of the device in that the (trade) name of the customer is shown on a display panel or possible product choices for selection are geared to the customer. It is also possible to store a library of customer-specific recipes for different distributors in the device, after which the control system will address the correct recipe on the basis of the customer identification read from the product holder.

A further preferred embodiment of the device according to the invention has the feature that the information carrier is electronically rewritable and that electronic programming means are provided at least close to the placing space which are able and adapted to store information in the information carrier of a product holder placed therein. The control system can thus fully interact with the product holders, for instance by storing current stock information therein in accordance with the number and the size of the dosages drawn therefrom or for instance a date of opening of the product holder. In addition to being available in an initial device itself, this information is then also available in another similar device if the product holder is transferred thereto. The date of opening can for instance thus be checked by a control system of the device and a product holder deemed as being “too old” can be rejected by the control system and thus blocked for use in the device. In the case of a less far-reaching autonomy of the control system a warning or message can optionally also be generated to a user that the holder in question has to be replaced. Numerous variations can be envisaged in this respect for providing a further guarantee of the quality and integrity of the product in question.

Information carriers of diverse nature are per se suitable for the product holder in the device according to the invention. A visible and optically readable code can thus be applied for this purpose, in particular a barcode. Use can also be made of an information carrier provided with electronically readable memory means. A preferred embodiment of the device according to the invention has in this respect the feature that the information carrier is suitable and adapted for wireless information transfer. The reading means are adapted hereto and thus able to obtain information from the information carrier in contactless manner and without line of sight being necessary. This enables a great measure of freedom in design in respect of the positioning of the reading means close to the placing space, and furthermore a reliable information exchange. A further particular embodiment of the device according to the invention has in this respect the feature that the information carrier comprises a radiographic transponder. Such a transponder, also referred to as RFID or RF-TAG, has the advantage that it does not require its own electrical power supply and can be arranged at a relatively low cost price, whereby it is suitable for a disposable product such as the product holder according to the invention.

In order to achieve the first stated object, a preferred embodiment of the device according to the invention has the feature that the outflow opening of the product holder is at least initially provided with a removable seal which comprises a foil folded back on itself, a base part of which is attached to an edge of the outflow opening and a folded further part of which leads back to a front side of the placing space facing toward the outlet and protrudes with a pulling part out of the placing space, and that at least the folded part of the foil is laterally movable inside the placing space in order to allow removal of the foil from a product holder placed in the placing space.

In order to exchange a product holder an empty product holder is removed from the device and a new, still unopened product holder is inserted into the placing space of the dosing device which at that moment is normally situated in the device. The folded foil sealing the outflow opening of the still unopened product holder can then be pulled loose from the front side using the pulling part while the product holder is situated in the placing space. The dosing device need not be taken out of the device for this purpose, but can remain in the device. This not only saves an operation, but also avoids the danger of spillage on a surface by the user, whereby the outlet of the dosing device thus no longer need be closed. While in the known device making the mistake of not opening the outlet of the dosing device following exchange of a product holder automatically resulted in an obstacle to reactivation of the device or even a malfunction, in the device according to the invention this source of malfunction is thus removed. In addition to providing an enhanced convenience of use, the invention also provides an improved operational reliability.

For the purpose of a correct and stable placing of a product order a preferred embodiment of the device according to the invention has the feature that the placing space comprises a shape lock in which the product holder can be placed at least substantially form-fittingly. The fit resulting from such a shape lock reduces the play a product holder has in the device, whereby it will automatically take up a correct and stable position. In a first particular embodiment the device according to the invention is characterized here in that the shape lock comprises a substantially rectangular recess into which the product holder can be placed at least substantially form-fittingly with a similarly formed base part, while in a further particular embodiment the device according to the invention has the feature that the shape lock comprises a guide slot in which an edge of the product holder can be moved close-fittingly. In the former case a new product holder can be inserted directly into the placing space, while in the latter case the product holder is guided via the guide slot into the correct position.

A further preferred embodiment of the device has the feature that the placing space comprises manually releasable snap means which are able and adapted to fix the product holder in a correct position. The snap means snap a product holder fixedly in a correct position, whereby a user receives a recognizable, i.e. perceptible indication thereof. The product holder is then also fixed in this position and so kept from undesirable release from the dosing device.

For a sufficient shelf-life of a product received in the product holder it is important that a holder which has not yet been opened is sufficiently hermetically sealed. With a view hereto a further particular embodiment of the device according to the invention has the feature that the foil comprises an optionally metallized plastic foil or a metal foil which has been attached to the edge of the outflow opening and seals an unopened product holder vapour-tightly. In respect of the product in the product holder, this particularly involves in the case of the device according to the invention a loose product from a group comprising powdered milk, sugar, cocoa powder, tea powder and coffee powder. These dry ingredients thus remain dry and lump-free for a long time in unopened state.

In order to achieve the second stated objective the device according to the invention has the feature that the dosing device forms part of a dosing unit with at least one further dosing device with a placing space having at least one further product holder which is provided with a further electronically readable information carrier, that electronic reading means are likewise provided at least close to the further placing space which are able and adapted to read information from the further information carrier of the product holder placed therein. Use is thus not made of separate dosing devices, one for each product as in the known device, but the dosing device is combined in a multiple dosing unit with at least one further dosing device. The dosing devices can hereby impart strength and stability to each other, this resulting in a more stable and so more reliable operation. This is particularly the case in a further particular preferred embodiment of the device according to the invention characterized in that the dosing unit comprises separate product chambers adjacently of each other in a connected, in particular unitary body.

In a further particular embodiment the device according to the invention has the feature that the product chambers each comprise on the outlet side an outlet which is in open communication with the inlet of a shared mixing chamber.

The present invention also relates to a product holder provided with an electronically readable information carrier for application in the described device according to the invention, and will now be further elucidated on the basis of an exemplary embodiment and an associated drawing. In the drawing:

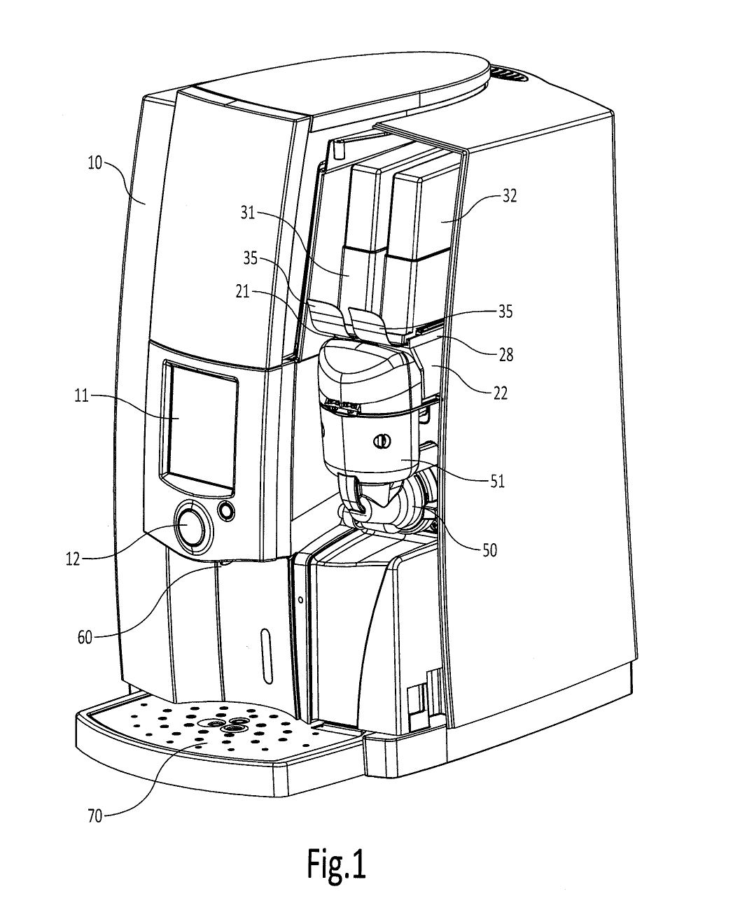

FIG. 1 shows a front view of an exemplary embodiment of a device according to the invention;

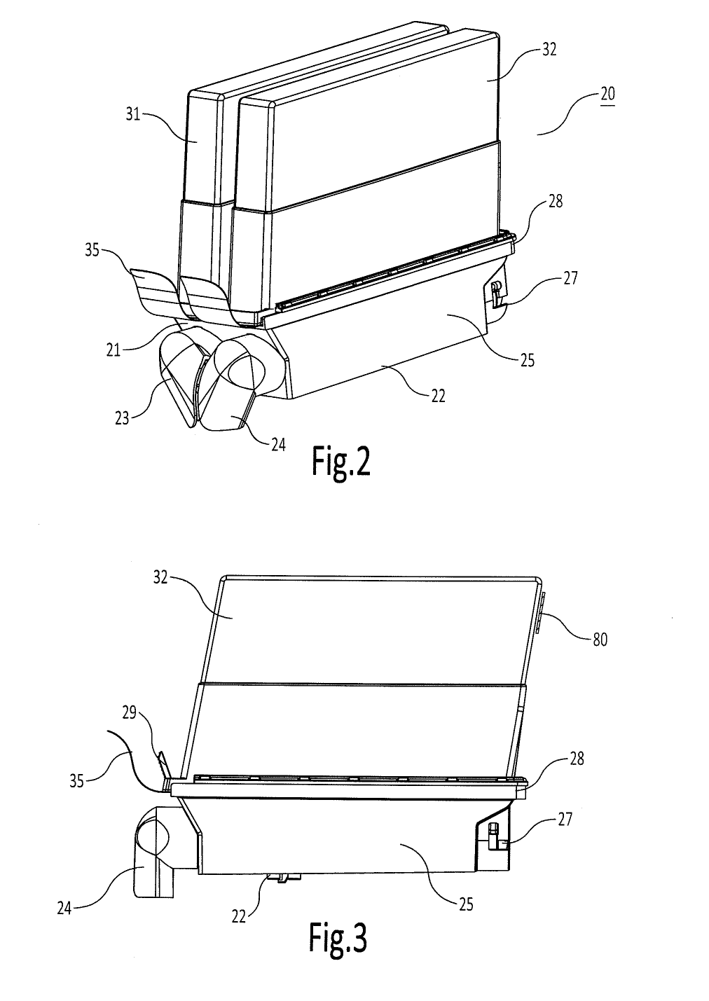

FIG. 2 is a perspective view of a multiple dosing unit as applied in the device of FIG. 1;

FIG. 3 is a side view of the dosing unit of FIG. 2;

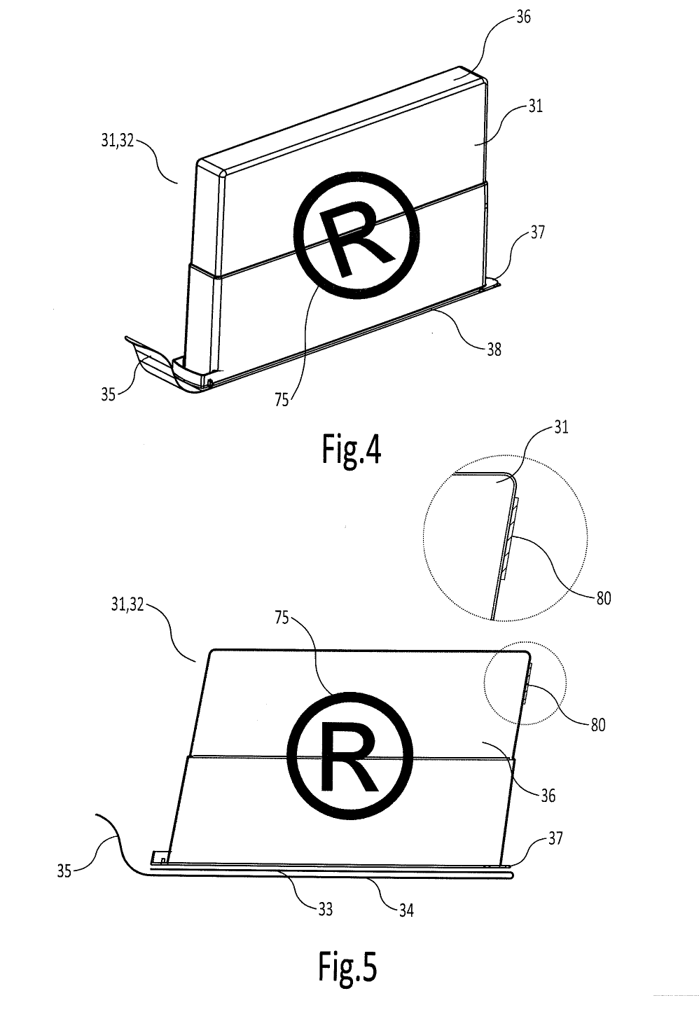

FIG. 4 is a perspective view of an exemplary embodiment of a product holder according to the invention as can be applied with the dosing unit of FIG. 2; and

FIG. 5 is a side view of the product holder of FIG. 4.

The figures are otherwise substantially schematic and not drawn to scale. For the sake of clarity some dimensions and components in particular may be exaggerated to a greater or lesser extent. Corresponding parts are designated as far as possible in the figures with the same reference numeral.

FIG. 1 shows a device for preparing and dispensing a beverage. This is a desk-size coffee machine, for instance for an office environment, although the invention can also be applied as larger or smaller size device. The device can be applied with a removable and refillable water tank or, as in the present case, be connected on a rear side to a fixed water main. The device is further provided with a mains current connection as power supply for all electrical and electronic components, and a wireless or non-wireless telecommunication interface can optionally be present therein which enables the device to exchange for instance status data with a central information system or online software, in particular firmware, in order to obtain updates. The shown device can be used without charge, although in some cases a coin operation or other transaction system can be applied therein.

The device comprises a stylish plastic housing 10 having on a front side a user interface in the form of a display panel 11 on which product selection options, status messages and related information can be displayed, in combination with a rotary/pushbutton 12 with which it is possible to run through successive selection options by means of rotation and to enter a selection therefrom by pressing. The user interface 11, 12 is coupled internally to an electronic control system which fully controls and monitors operation of the device.

In the shown situation a manually removable front panel on the right-hand side is taken away whereby access is gained to a dosing unit 20, see also FIGS. 2 and 3. Dosing unit 20 comprises a first dosing device 21 with a first product holder 31 and a second dosing device 22 with a second product holder 32. Both dosing devices 21, 22 have a separate outlet 23, 24 which debouch in a funnel inlet 51 of a shared mixing chamber 50. Mixing chamber 50 is also provided internally with an inlet for hot water which is obtained from the water main and which is heated by means of a heat block (thermo-block) or optionally open boiler system to a desired preparation temperature in the device.

Situated inside each of the dosing devices is a product chamber 25 having therein an axially running worm wheel, which is not further shown as it is assumed sufficiently known to a skilled person. The worm wheel extends on a rear side from a hollow polygonal gear wheel 27 which is placed on a corresponding shaft extending in the device from an inner wall behind the dosing unit. A rotation of this shaft, and thereby of the worm wheel, in the product chamber forces the product forward, where it can leave the dosing device at outlet 24. The individual shafts of the dosing devices 21, 22 are controlled here from the control system of the device in order to give a number of turns corresponding to a desired dosage of the relevant product.

Both dosing devices 21, 22 extend from a multiple dosing unit 20 comprising on a base a unitary plastic body in which the product chambers 25 of both dosing devices are accommodated. On a rear side the dosing unit comprises two gear wheels 27, one for each dosing device, which are placed together on a corresponding set of drive shafts of the device which extend from the inner wall. Each dosing device is provided on an inlet side with an exchangeable product holder 31, 32 in which quantity of a loose product of varied nature is held, such as for instance sugar, powdered milk, cocoa powder, tea powder or coffee powder.

The product holders are placed here in a shape lock which in the shown embodiment is formed by a guide slot 28 in which the product holder can be moved in fitting manner with an edge part 38. Edge part 38 of product holder 31 is inserted from the front side into the guide slot and pushed to the rear until snap means 29 provided for the purpose fix the product holder. The snap means are resilient and provided with an operating member with which the fixation can be manually released so as to enable release and removal of an empty product holder.

Product holders 31, 32, see also FIGS. 4 and 5, each comprise a block-shaped package 36 of cardboard, plastic or other suitable, preferably at least partially transparent material which is attached to a relatively form-retaining plastic base part 37 from which edge part 38 also extends. The base part is open on an underside, although in unopened state of the holder is hermetically sealed in airtight and vapour-tight manner with appropriate sealing, such as in this case a metallized plastic foil or metal foil 33 . . . 35. The foil here comprises a first part 33, see FIG. 5, attached to edge 38 around an outflow opening in the underside of the product holder, and a folded part 34 which leads back to a front side and protrudes outside the dosing device with a pulling part in the form of a tab 35.

In order to remove the foil from the underside of the product holder, the product holder can remain in the placing space because the foil remains axially movable therein. By pulling on pulling part 35 the first part 33 of the foil is peeled off the underside of product holder 31, 32 and thus leaves clear the outflow opening, whereby the product falls out of product holder 31, 32 into product chamber 25 of the relevant dosing device.

In accordance with a further aspect of the invention, the product holder comprises an information carrier 80 which is electronically readable with reading means provided for this purpose in device 10 and in this example is moreover writable using programming means of the device. Information carrier 80 comprises in this example a radiographic transponder, also referred to as RFID or RF tag, in which information, such as a unique individual or collective (batch) identification of the product holder, a product identification, product recipe or a customer identification, is stored and is readable. Such a tag, in addition to the relatively low cost price, has the advantage that no separate on-board electronic power supply is required therefor. The transponder instead draws a supply voltage from the radiographic carrier wave which is thereby incorporated.

Applied in this example is a special type of ID 80 which also allows information to be written therein. Stock information and shelf-life information, i.e. a date of opening of holder 31, 32, can thus be stored in information carrier 80, which are subsequently available irrespective of the specific device in which the product holder is placed.

The provision of such an electronic information carrier in, at or on product holder 31, 32 offers an unrivalled range of new application options, including far-reaching personalization of the device as a whole and the user interface 11, 12 in particular. This may involve a listing of customer-specific selection options and customer-specific product recipes based on information read from the information carrier. In order to further emphasize the customer-specific or user-specific character of product holder 31, 32 a trade-name, logo, own design or other specific form of expression 75 can be depicted on the holder or otherwise added thereto.

Although the invention has been further elucidated above with reference to only a single exemplary embodiment, it will be apparent that the invention is by no means limited thereto. On the contrary, many other variations and embodiments are possible within the scope of the invention for the person with ordinary skill in the art.

Use is thus made in the exemplary embodiment of a shape lock by means of a fitting slotted guiding of the product holder, although a fitting recess or other product space can also be applied instead in which the product holder can be placed and preferably fixed, for instance snapped fixedly, in stable manner.

Nor is the device limited in its application to the given examples of products, but can be utilized for any random product which has to be dispensed automatically and dosed in controlled manner.

1. Device for preparing and dispensing a drink, comprising a mixing chamber with supply means for a liquid, in particular hot water, with at least one dosing device for a controlled delivery of a product to be mixed with the liquid in the mixing chamber, and with an outlet at which a prepared drink can be drawn off, wherein the dosing device comprises a product chamber from where the product is dispensed in controlled manner on an outlet side and wherein the dosing device is provided on an inlet side with a placing space with an exchangeable product holder in open communication at an outflow opening with the product chamber, characterized in that the product holder is provided with an electronically readable information carrier, that at least close to the placing space electronic reading means are provided which are able and adapted to read information from the information carrier of a product holder placed therein, and that the reading means are coupled to an electronic control system which controls the device on the basis of at least the information thus readable from the product holder.

2. Device as claimed in claim 1, characterized in that the information carrier comprises an at least substantially unique product holder identification and that the product holder identification is readable by the reading means.

3. Device as claimed in claim 1, characterized in that the information carrier comprises a product identification of a product arranged in the product holder and that the product identification is readable by the reading means.

4. Device as claimed in claim 3, characterized in that the information carrier comprises a recipe for a drink to be prepared from at least a product received in the product holder, and that the recipe is readable by reading means.

5. Device as claimed in claim 4, characterized in that the information carrier comprises a customer identification and that the customer identification is readable by the reading means.

6. Device as claimed in claim 1, characterized in that the information carrier is electronically rewritable and that electronic programming means are provided at least close to the placing space which are able and adapted to store information in the information carrier of a product holder placed therein.

7. Device as claimed in claim 1, characterized in that the information carrier is suitable and adapted for wireless information transfer.

8. Device as claimed in claim 7, characterized in that the information carrier comprises a radiographic transponder.

9. Device as claimed in claim 1, characterized in that the dosing device forms part of a dosing unit with at least one further dosing device with a placing space having at least one further product holder which is provided with a further electronically readable information carrier, that electronic reading means are likewise provided at least close to the further placing space which are able and adapted to read information from the further information carrier of the product holder placed therein.

10. Device as claimed in claim 9, characterized in that the dosing unit comprises separate product chambers adjacently of each other in a connected, in particular unitary body.

11. Device as claimed in claim 10, characterized in that the product chambers each comprise on the outlet side an outlet which is in open communication with the inlet of a shared mixing chamber.

12. Device as claimed in claim 1, characterized in that the outflow opening of the product holder is at least initially provided with a removable seal which comprises a foil folded back on itself, a base part of which is attached to an edge of the outflow opening and a folded further part of which leads back to a front side of the placing space facing toward the outlet and protrudes with a pulling part out of the placing space, and that at least the folded part of the foil is laterally movable inside the placing space in order to allow removal of the foil from a product holder placed in the placing space.

13. Device as claimed in claim 12, characterized in that the foil comprises an optionally metallized plastic foil or a metal foil which has been attached to the edge of the outflow opening and seals an unopened product holder vapour-tightly.

14. Device as claimed in claim 1, characterized in that the placing space comprises a shape lock in which the product holder can be placed at least substantially form-fittingly.

15. Device as claimed in claim 14, characterized in that the shape lock comprises a substantially rectangular recess into which the product holder can be placed at least substantially form-fittingly with a similarly formed base part.

16. Device as claimed in claim 15, characterized in that the shape lock comprises a guide slot in which an edge of the product holder can be moved close-fittingly.

17. Device as claimed in claim 1, characterized in that the placing space comprises manually releasable snap means which are able and adapted to fix the product holder in a correct position.

18. Device as claimed in claim 1, characterized in that the product holder comprises a loose product from a group comprising powdered milk, sugar, cocoa powder, tea powder and coffee powder.

19. Product holder provided with an electronically readable information carrier for application in the device as claimed in claim 1.
